(19) United States
(12) Patent Application Publication
(10) Pub. No.: US 2024/0353803 A1
(43) Pub. Date: Oct. 24, 2024

(54) COMPUTER SYSTEM AND APPARATUS CONDITION SEARCH SUPPORT METHOD

(71) Applicant: Hitachi, Ltd., Tokyo (JP)

(72) Inventors: Takeshi OHMORI, Tokyo (JP); Yutaka OKUYAMA, Tokyo (JP); Hyakka NAKADA, Tokyo (JP)

(21) Appl. No.: 18/684,866

(22) PCT Filed: Aug. 12, 2022
(86) PCT No.: PCT/JP2022/030799

§ 371 Date: Feb. 20, 2024

(30) Foreign Application Priority Data
Nov. 4, 2021 (JP) 2021-180254

(51) Int. Cl. G05B 13/02

(52) U.S. Cl. CPC G05B 13/0265

(57) ABSTRACT

A computer system is configured to: receive input of a plurality of pieces of learning data, a piece of learning data includes a combination of a value of at least one input parameter which is the apparatus condition and a value of at least one output parameter which is a result of processing; analyze a structure of manufacturing steps of the processing in a piece of standard learning data and a structure of manufacturing steps of the processing in a piece of other learning data; execute, based on a result of the analysis, classification processing of identifying a piece of learning data which is aggregable with a same dataset as the piece of standard learning data; generate a dataset; execute processing of training a model; execute search processing of searching for the value of the at least one input parameter; and present a result of the search processing.

### INCORPORATION BY REFERENCE

This application claims priority to Japanese Patent Application No. 2021-180254 filed on Nov. 4, 2021, the content of which is incorporated herein by reference.

### BACKGROUND OF THE INVENTION

This invention relates to a system for supporting a search for apparatus conditions of a manufacturing apparatus and a method of supporting a search for apparatus conditions of a manufacturing apparatus.

In control apparatus of recent years, control performance and manufacturing performance have been strengthened by providing the control apparatus with a plurality of control knobs (control conditions) in order to increase the types of materials and structures that can be handled, and at the same time significantly improve accuracy, speed, operating rate, and operating costs.

One method for improving the processing accuracy, processing speed, operating rate, operating costs, and the like of a manufacturing apparatus is to optimize the apparatus conditions. In particular, optimization of the apparatus conditions is important in order to improve processing accuracy and achieve a target processing shape.

In order to bring out the performance of a manufacturing apparatus, it is required to determine many input parameters, that is, apparatus conditions, corresponding to a large number of control knobs. Further, in order to implement a processing result having a higher degree of difficulty, there is used a method in which a plurality of manufacturing steps are provided within one series of processing, and the input parameters are changed for each step. Therefore, it has become very difficult to determine a combination of input parameters that yields a target processing result, leading to longer development time of the processing conditions and increased development and operational costs. Moreover, the demand for processing having a higher degree of difficulty is increasing, and there is a shortage of engineers with the advanced knowledge and skills to handle this demand.

Thus, there is a demand for a system for supporting the engineers who optimize the apparatus conditions of manufacturing apparatus. Further, there is a demand for a highly simple and convenient system that allows engineers without specialized knowledge to use the support functions.

In JP 2019-040984 A, there is disclosed a method of optimizing conditions of a semiconductor manufacturing apparatus. Further, in JP 2003-50871 A, there is disclosed a method of reducing the money and costs that users spend on simulation by publishing a processing result simulator for semiconductor manufacturing on the Internet.

### SUMMARY OF THE INVENTION

One way to support engineers is to provide an optimal condition search system using a processing result simulator or a processing shape prediction model which uses machine learning and deep learning.

However, many of the simulation models and learning models that are capable of handling highly difficult processing require data scientists and engineers who have knowledge of scientific calculations and programming, and there is a problem in that execution is difficult because scripts and commands are required in order to specify the required apparatus conditions and run the simulator. In addition, there is a large number of procedures from constructing a dataset to running calculations, and it is often required to use a plurality of pieces of software in the process. Moreover, there is a shortage of engineers having knowledge of scientific calculations and programming.

Therefore, it is required to provide a highly simple and convenient system that can be used by general engineers. Specifically, there is required a one-stop system from data input to investigation of apparatus conditions which eliminates the requirement for commands and script creation.

A calculation result of the optimal apparatus conditions strongly depends on the learning dataset and calculation settings, and hence, in order to improve user convenience during the apparatus condition search, it is very important to simplify changes to the learning dataset and calculation settings and simplify the management of how the results are held.

In particular, in the construction of a learning dataset, it is important to select, from among all the data or data which has been obtained, the data that can maintain or improve the prediction accuracy of the apparatus conditions by the apparatus condition search model. Therefore, it is important to be able to easily construct a learning dataset.

In JP 2019-040984 A, there is disclosed a method of optimizing conditions of a semiconductor manufacturing apparatus by using a learning model. As described above, in order to solve the shortage of engineers in optimizing apparatus conditions, it is required that such a method be usable even to general engineers.

Further, in JP 2003-50871 A, there is disclosed a method in which a processing shape simulator is published on the Internet and is usable by a plurality of users. In order to search for the optimal apparatus conditions, it is required that even a general engineer be able to incorporate not only the predicted shape but also actual experimental data into predictions and to improve the prediction model.

It is an object of this invention to provide a system for supporting a search for apparatus conditions of a manufacturing apparatus, and in particular, supports construction of a learning dataset.

A representative example of the present invention disclosed in this specification is as follows: a computer system for supporting a search for an apparatus condition for controlling a manufacturing apparatus that performs processing, the computer system comprises at least one computer including a calculation device, a storage device coupled to the calculation device, and a coupling interface coupled to the calculation device. The processing includes at least one manufacturing step. The computer system is configured to: present a first interface for receiving input of a plurality of pieces of learning data, a piece of learning data includes a combination of a value of at least one input parameter which is the apparatus condition and a value of at least one output parameter which is a result of the processing; store the plurality of pieces of learning data input via the first interface in the storage device; analyze a structure of the at least one manufacturing step of the processing in a piece of standard learning data and a structure of the at least one manufacturing step of the processing in a piece of other learning data, and based on a result of the analysis, execute classification processing of identifying a piece of learning data which is aggregable with a same dataset as the piece of standard learning data; generate a dataset by aggregating the plurality of pieces of learning data based on a result of the classification processing; execute, by using the dataset, processing of training a model for predicting the value of the at least one output parameter from the value of the at least one input parameter, and store the generated model in the storage device; execute search processing of searching for the value of the at least one input parameter based on the model and a target value of the at least one output parameter; and present a second interface for displaying a result of the search processing.

According to the at least one representative embodiment of this invention, it is possible to support the construction of the learning dataset. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a block diagram for illustrating an example of a configuration of a system according to a first embodiment of this invention;

FIG. 2 and FIG. 3 are flowcharts for illustrating an example of processing executed by an apparatus condition search support system of the first embodiment;

FIG. 4 is a diagram for illustrating an example of a screen presented by the apparatus condition search support system of the first embodiment;

FIG. 5 is a table for showing an example of an operation field presented by the apparatus condition search support system of the first embodiment in a case where an input data button 410 is operated;

FIG. 6A, FIG. 6B, FIG. 6C, FIG. 6D, and FIG. 6E are tables for showing update examples of input/output data information by the apparatus condition search support system of the first embodiment

FIG. 7 is a diagram for illustrating an example of a screen presented by the apparatus condition search support system of the first embodiment in a case where a create dataset button is operated;

FIG. 8 is a table for showing an example of a screen presented by the apparatus condition search support system of the first embodiment in a case where a manual creation button is operated;

FIG. 9 is a flowchart for illustrating an example of processing executed by the apparatus condition search support system of the first embodiment;

FIG. 10 is a diagram for illustrating an example of a screen presented by the apparatus condition search support system of the first embodiment in a case where a create workspace button is operated;

FIG. 11 is a diagram for illustrating an example of a screen presented by the apparatus condition search support system of the first embodiment in a case where a set preprocessing button is operated; and

FIG. 12A and FIG. 12B are diagrams for illustrating an example of a screen presented by the apparatus condition search support system of the first embodiment in a case where a set calculation button is operated.

### DETAILED DESCRIPTION OF THE PREFERRED EMBODIMENTS

Now, description is given of at least one embodiment of this invention referring to the drawings. It should be noted that this invention is not to be construed by limiting the invention to the content described in the following at least one embodiment. A person skilled in the art would easily recognize that specific configurations described in the following at least one embodiment may be changed within the scope of the concept and the gist of this invention.

In configurations of the at least one embodiment of this invention described below, the same or similar components or functions are denoted by the same reference numerals, and a redundant description thereof is omitted here.

Notations of, for example, “first”, “second”, and “third” herein are assigned to distinguish between components, and do not necessarily limit the number or order of those components.

The position, size, shape, range, and others of each component illustrated in, for example, the drawings may not represent the actual position, size, shape, range, and others in order to facilitate understanding of this invention. Thus, this invention is not limited to the position, size, shape, range, and others disclosed in, for example, the drawings.

### First Embodiment

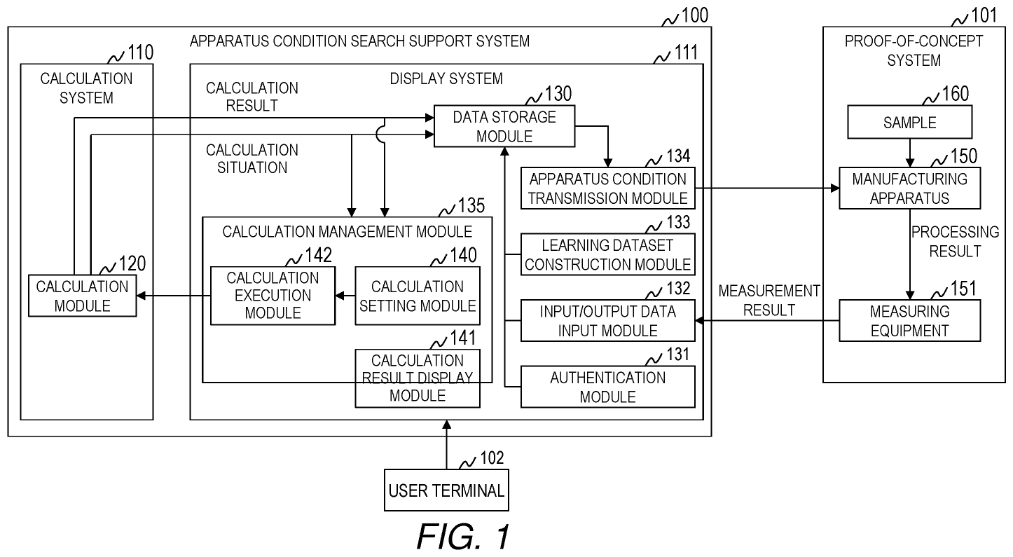

FIG. 1 is a block diagram for illustrating an example of a configuration of a system according to a first embodiment of this invention.

The system includes an apparatus condition search support system 100 and a proof-of-concept system 101. The apparatus condition search support system 100 and the proof-of-concept system 101 are coupled to each other directly or via a network.

A user terminal 102 is coupled to a display system 111. A user performs various operations via a graphical user interface (GUI) presented by the display system 111 on the user terminal 102. Specifically, the user performs inputs and the like required for execution of functions of a calculation execution module 142.

The proof-of-concept system 101 performs experiments which use a manufacturing apparatus based on apparatus conditions input from the apparatus condition search support system 100. The proof-of-concept system 101 includes a manufacturing apparatus 150 and measuring equipment 151. In the proof-of-concept system 101, a sample 160 to be processed is introduced into the manufacturing apparatus 150, and processing is executed on the sample 160 based on the received apparatus conditions. The processed sample 160 is output from the manufacturing apparatus 150 to the measuring equipment 151 as a processing result. The measuring equipment 151 measures the processed sample 160, and transmits a measurement result to the apparatus condition search support system 100. The measurement result is registered in a data storage unit 130 as output data by an input/output data input module 132.

The data obtained as the measurement result is, for example, an image. In a case where a feature amount, for example, dimensions and size in an image, is obtained by using measurement software or the like, the result obtained by using the measurement software becomes the measurement result. In addition, sensor data, for example, obtained by the manufacturing apparatus 150 may be handled as a processing result. In this case, measurement by the measuring equipment 151 is not required, and thus the sensor data, for example, is transmitted to the apparatus condition search support system 100 as the measurement result.

The manufacturing apparatus 150 is an apparatus having apparatus conditions which require optimization. The manufacturing apparatus 150 is, for example, a semiconductor manufacturing apparatus, a film forming apparatus, a modeling apparatus (for example, 3D printer), a cleaning apparatus, a coating apparatus, a transportation apparatus, a packaging apparatus, a machining apparatus, or a construction apparatus (for example, heavy machinery). Specific examples of the semiconductor manufacturing apparatus include a lithography apparatus, a film forming apparatus, a patterning apparatus, an ion implantation apparatus, a heating apparatus, and a cleaning apparatus. Examples of the lithography apparatus include an exposure apparatus, an electron beam lithography apparatus, and an X-ray lithography apparatus. Examples of the film forming apparatus include a chemical vapor deposition (CVD), a physical vapor deposition (PVD), a vapor deposition apparatus, a sputtering apparatus, and a thermal oxidation apparatus. Examples of the patterning apparatus include a wet etching apparatus, a dry etching apparatus, an electron beam processing apparatus, and a laser processing apparatus. Examples of the ion implantation apparatus include a plasma doping apparatus and an ion beam doping apparatus. Examples of the heating apparatus include a resistance heating apparatus, a lamp heating apparatus, and a laser heating apparatus. Examples of the cleaning apparatus include a liquid cleaning apparatus and an ultrasonic cleaning apparatus.

The apparatus condition search support system 100 searches for the apparatus conditions to be set in the manufacturing apparatus 150. The apparatus condition search support system 100 transmits the apparatus conditions obtained by the search processing to the proof-of-concept system 101. The apparatus condition search support system 100 includes a calculation system 110 and the display system 111. In the following description, each type of processing in the search processing is referred to as “calculation.”

The calculation system 110 and the display system 111 are each formed from a computer including a processor, a memory, a network interface, an input device, and an output device. The number of computers forming each system is not limited.

The calculation system 110 includes a calculation unit 120. The display system 111 includes the data storage unit 130, an authentication module 131, the input/output data input module 132, a learning dataset construction module 133, an apparatus condition transmission module 134, and a calculation management module 135. The calculation management module 135 includes a calculation setting module 140, a calculation result display module 141, and the calculation execution module 142.

In a case where the authentication module 131 is accessed by the user, the authentication module 131 displays a login screen. The login screen is a general display screen, and thus is not shown. The authentication module 131 manages information associating an input such as a user name, an access password, and a group to which the user belongs with an access-permitted area, and determines whether or not access is permitted based on the information.

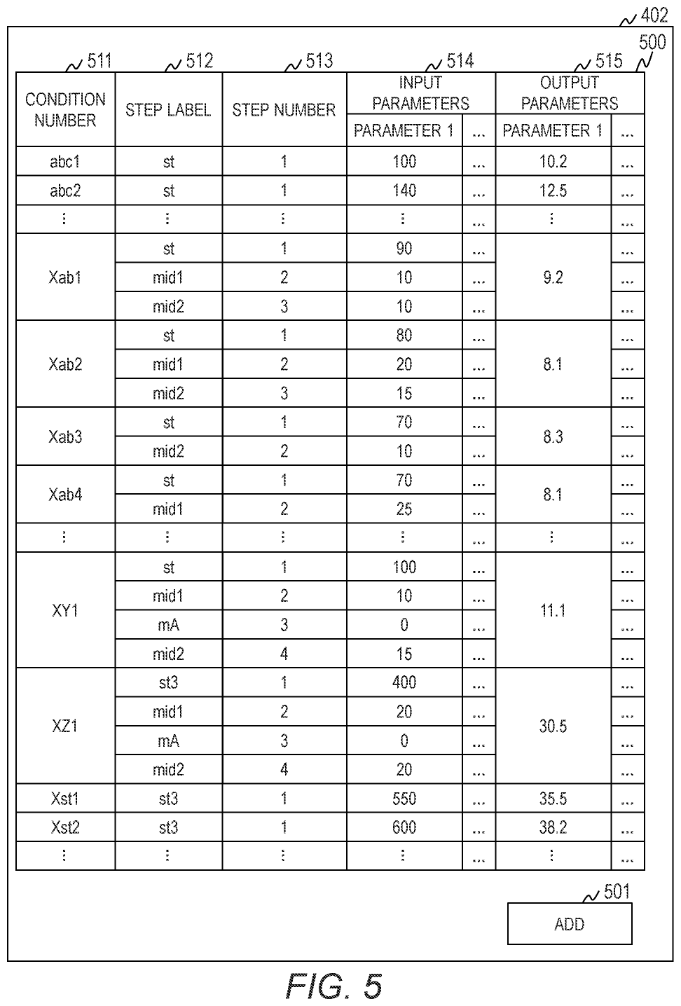

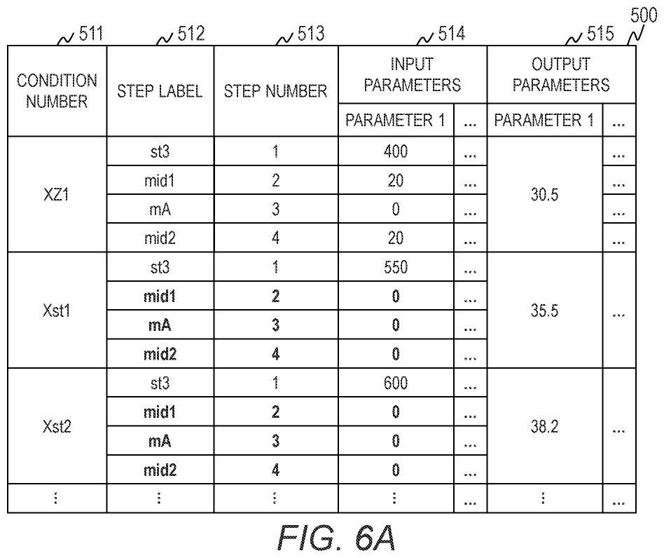

In a case where the login processing is complete, the display system 111 displays a screen for inputting data to be used for learning, which is shown in FIG. 5. The input/output data input module 132 registers and deletes input data and output data, and sets and displays label names and parameter names, for example, of data display columns.

The input data is a combination of values of parameters, which are the conditions for controlling the manufacturing apparatus 150, and the output data is the processing result of the manufacturing apparatus 150. In the following description, a pair of input data and output data is referred to as “input/output data.” The input/output data is used as data for training a search model.

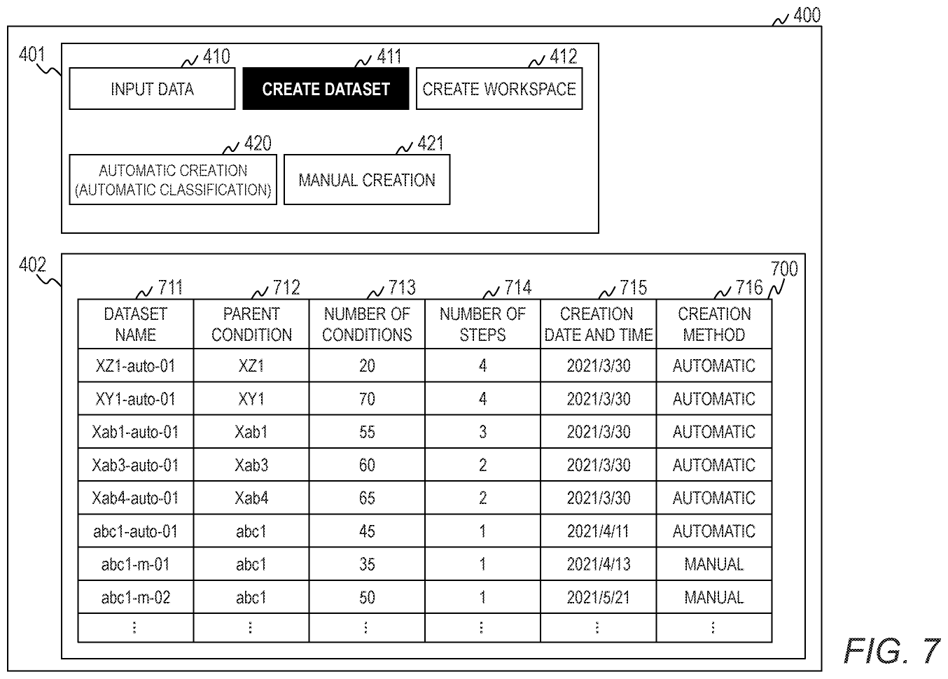

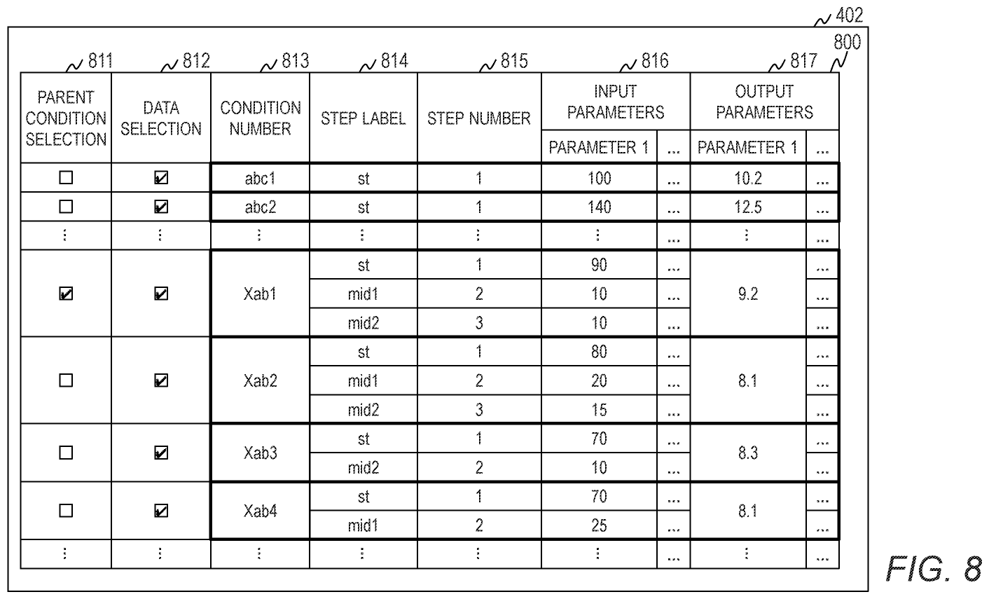

In a case where the input of the input/output data by the user is complete, the display system 111 displays a screen for constructing a learning dataset, which is illustrated in FIG. 7 and FIG. 8. The learning dataset construction module 133 constructs datasets, manages information accompanying the datasets, and displays types of various information.

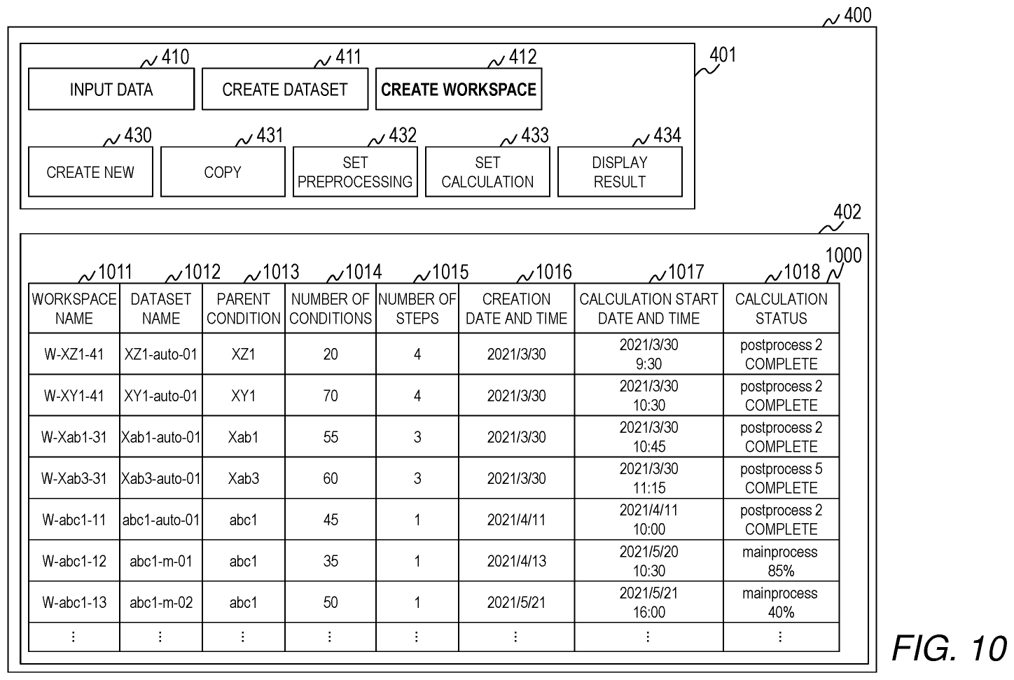

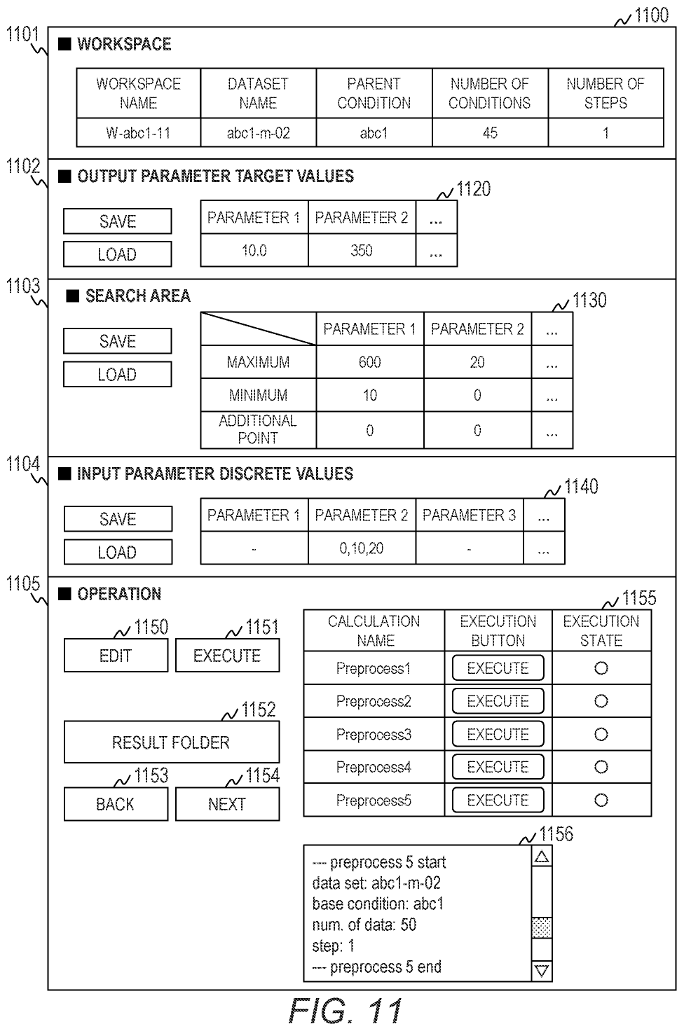

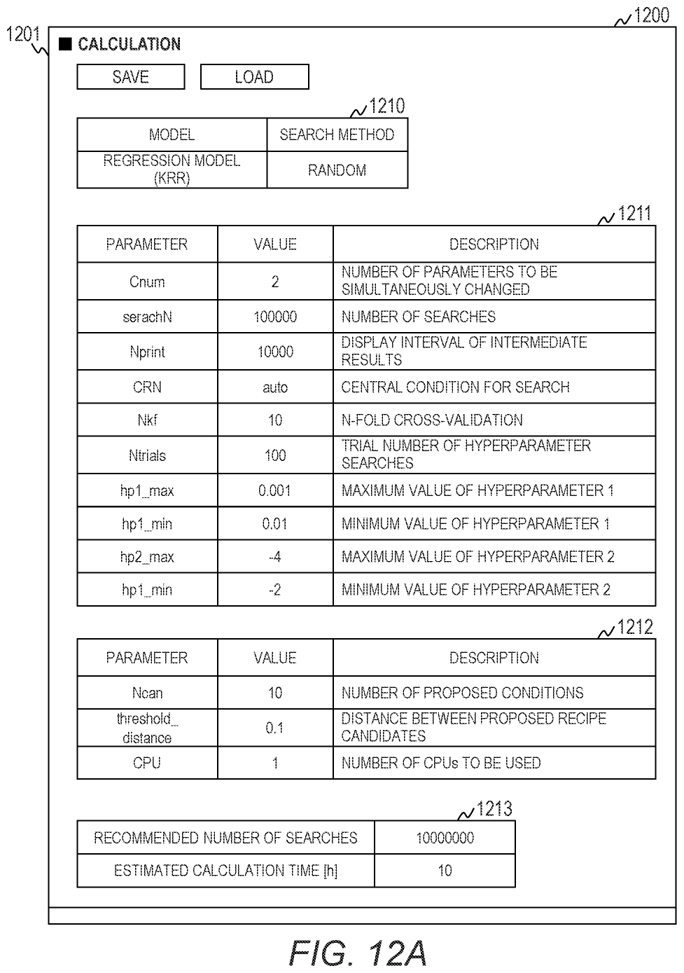

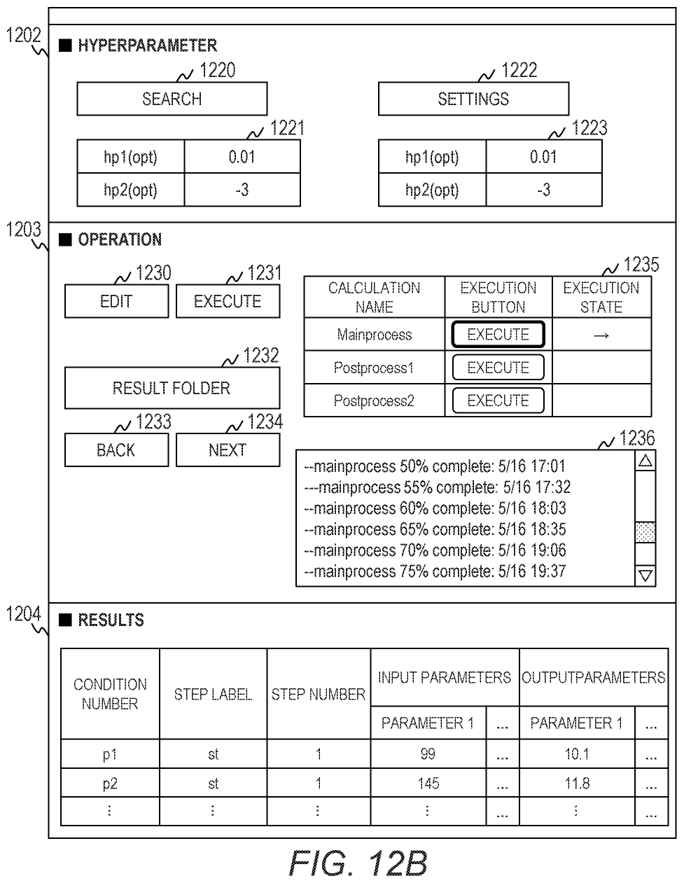

In a case where the construction of the learning dataset by the user is complete, the display system 111 displays a screen for performing various settings relating to calculations. This screen includes, as described below, a screen for creating and managing a workspace, which is illustrated in FIG. 10, a screen for performing preprocessing settings, which is illustrated in FIG. 11, and a screen for performing settings of the search model, which is illustrated in FIG. 12A and FIG. 12B. Each functional module of the calculation management module 135 reflects the settings performed by using the above-mentioned screens, displays a status of the calculations and calculation results, gives instructions to execute calculations, and outputs and manages the results obtained from the calculation system 110. The calculation management module 135 may simultaneously execute the settings and calculations and display the results, or may cause the calculation unit 120 to simultaneously execute a plurality of calculations.

The data storage unit 130 manages the various types of information handled by the display system 111.

The apparatus condition transmission module 134 obtains the apparatus conditions from the data storage unit 130, and transmits the obtained apparatus conditions to the manufacturing apparatus 150.

The calculation system 110 and the display system 111 may be integrated into one system. Further, the arrangement of the functional units and modules of the calculation system 110 and the display system 111 can be set in any way. For example, the calculation management module 135 may be included in the calculation system 110. In addition, a plurality of the functional units or modules included in the apparatus condition search support system 100 may be combined into one functional unit or module, or one functional unit or module may be divided into a plurality of functional units or modules for each function.

In this embodiment, description is given of a system which searches for the apparatus conditions of the manufacturing apparatus 150, but even for an inspection apparatus, an observation apparatus, or a measurement apparatus, it is important to optimize the apparatus conditions for implementing the target inspection, observation, or measurement. For example, in an observation by an electron microscope, an image of an object to be imaged can be obtained with optimal image quality by adjusting apparatus conditions such as a focus during imaging, an orientation of an observation plane, an observation position, and an electron beam acceleration voltage. Therefore, this invention can be applied to apparatus other than a manufacturing apparatus. Specific examples of apparatus to which this system can be applied include electron microscopes, laser microscopes, optical microscopes, film thickness measuring equipment, and three-dimensional dimension measuring equipment.

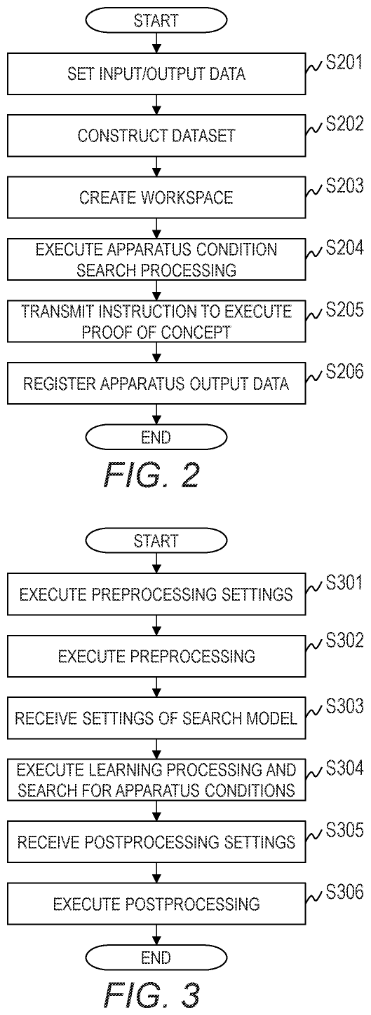

FIG. 2 and FIG. 3 are flowcharts for illustrating an example of processing executed by the apparatus condition search support system 100 of the first embodiment.

The apparatus condition search support system 100 starts the processing, which is described below, after the user login processing is complete.

First, the apparatus condition search support system 100 sets the input/output data based on inputs by the user via the screen (Step S201).

The apparatus condition search support system 100 constructs a learning dataset based on inputs by the user via the screen (Step S202).

The apparatus condition search support system 100 creates a workspace based on inputs by the user via the screen (Step S203). At this time, the user selects the dataset to be used for the calculations. The selection of the dataset may be performed at the same time as the workspace is created, or may be performed after the workspace is created.

The apparatus condition search support system 100 executes apparatus condition search processing (Step S204). In the processing, it is possible to set a plurality of calculations, execute each calculation, and display each calculation result. Details of the apparatus condition search processing are described with reference to FIG. 3.

The dataset, calculation settings, and calculation execution state are managed in association with one workspace. This improves the convenience of managing the apparatus conditions. The apparatus conditions strongly depend on the dataset and the calculation settings, and hence, in order to improve user convenience during the apparatus condition search, it is very important to simplify changes to the dataset and the calculation settings and simplify management of the calculation result.

The apparatus condition search support system 100 transmits, to the proof-of-concept system 101, an instruction to execute a proof of concept including the apparatus conditions (Step S205). The proof-of-concept system 101 executes the proof of concept based on the apparatus conditions, and transmits the processing result and the measurement result to the apparatus condition search support system 100.

In a case where the apparatus condition search support system 100 receives the processing result and the measurement result, the apparatus condition search support system 100 registers the processing result and the measurement result in the data storage unit 130 as output data (Step S206), and ends this processing. The output data is registered in association with the transmitted apparatus conditions (input data).

Through the above-mentioned series of processing steps, new input/output data is registered in the data storage unit 130. Through the execution of the same processing again by using new input/output data, it becomes possible to search for new apparatus conditions and perform a proof of concept based on the new apparatus conditions. Through the repeated execution of the processing illustrated in FIG. 2, the accuracy of the search for the apparatus conditions that enable the user to achieve a desired purpose can be greatly increased.

Moreover, through the specification of the dataset construction method and calculation setting conditions before the execution of the processing illustrated in FIG. 2, it is possible to automate construction of the dataset, execution of the calculations, continuation of the proof of concept, and registration of the input/output data. In addition, the apparatus condition search support system 100 can improve user convenience by displaying a progress status of the various processing steps to the user.

Next, the apparatus condition search processing is described with reference to FIG. 3.

The apparatus condition search support system 100 performs the settings relating to preprocessing of the data included in the dataset based on the inputs by the user via the screen (Step S301), and executes preprocessing based on those settings (Step S302).

The apparatus condition search support system 100 performs the settings relating to the search model based on the inputs by the user via the screen (Step S303), executes learning processing based on those settings, and also uses the search model to search for the apparatus conditions (Step S304). The search model is, for example, a model which receives input data as input and predicts output data.

The apparatus condition search support system 100 performs, based on inputs by the user via the screen, the settings relating to postprocessing to be performed on the search result (Step S305), executes the postprocessing based on those settings, and displays the processing result (Step S306).

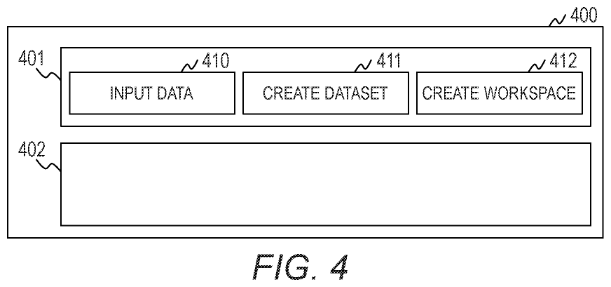

FIG. 4 is a diagram for illustrating an example of a screen presented by the apparatus condition search support system 100 of the first embodiment.

A screen 400 includes an operation button display field 401 and an operation field 402. The operation button display field 401 is a field which displays buttons for selecting operations to be performed by using the screen. The operation button display field 401 includes an input data button 410, a create dataset button 411, and a create workspace button 412. The operation field 402 is a field for presenting various types of information and setting various types of information. In the operation field 402, display corresponding to the operation button is performed.

FIG. 5 is a table for showing an example of the operation field 402 presented by the apparatus condition search support system 100 of the first embodiment in a case where the input data button 410 is operated.

In a case where the input data button 410 is pressed, input/output data information 500 and an add button 501 are displayed in the operation field 402. The input/output data information 500 is information having a table format, and stores entries including a condition number 511, a step label 512, a step number 513, input parameters 514, and output parameters 515. There is one entry for each condition.

The input data and the output data of each step included in the processing on the sample 160 are managed in association with the condition number. In a case where the relationship between the input data and the output data is to be learned, it is required that the correspondence between the inputs and the output of the manufacturing apparatus 150 be understood, and thus it is important to manage the data in a format like that described above.

The fields included in the entry are not limited to those described above. For example, in order to improve convenience, fields storing the names of the registered users, the names of the group to which each user belongs, and the date and time of registration may be included.

The input/output data information 500 is not limited to a table format, and may be in a cell format, a sheet format, an array format, or the like.

The condition number 511 is a field which stores identification information on the condition. The step label 512 is a field which stores a label given to the steps included in the processing on the sample 160. The step number 513 is a field which stores an execution order of the steps in the processing on the sample 160. The input parameters 514 are a group of fields which store the values of the input parameters. The input parameters 514 include one or more fields. The output parameters 515 are a group of fields which store the values of the output parameters. The output parameters 515 include one or more fields.

Like the entry having the condition number 511 “Xab1,” in order to implement advanced processing, each processing action includes a plurality of steps, and an input parameter is set for each step. The output parameters 515 are parameters relating to the processing result, and therefore one output parameter 515 is set for each entry. In a case where registered input/output data exists, the input/output data information 500 displays an entry corresponding to that input/output data.

The user presses the add button 501 to add an entry to the input/output data information 500, add a row for a step in the added entry, and set the values in the step label 512, the step number 513, the input parameters 514, and the output parameters 515 of each row. In a case where the add button 501 is pressed, the apparatus condition search support system 100 may separately display an input screen and add an entry to the input/output data information 500 based on inputs to the screen.

The values set in the input parameters 514 are usually numerical values, and an input restriction such as an upper limit value and a lower limit value, or a prohibited input range, is provided in the manufacturing apparatus 150. Therefore, the apparatus condition search support system 100 determines, in accordance with the input restriction, whether or not there is an error in the values input by the user. In a case where an inappropriate value is input, it is desired that the error value or the field in which the value is input be highlighted and displayed, and that the reason for the error be displayed to notify the user. Similarly, the values set in the output parameters are numerical values, and an upper limit value and a lower limit value, or a prohibited input range, corresponding to the sample 160 to be measured, is provided. Therefore, the apparatus condition search support system 100 determines, in accordance with a prohibited range, whether or not there is an error in the values input by the user. In a case where an inappropriate value is input, it is desired that the error value or the field in which the value is input be highlighted and displayed, and that the reason for the error be displayed to notify the user.

The apparatus condition search support system 100 may receive an operation for adding or deleting the fields of the input parameters 514 and the output parameters 515, and an operation for changing the name of a field. Further, the apparatus condition search support system 100 may be configured such that the number and the names of the fields of the input parameters 514 and the output parameters 515 can be set only for the first time.

The apparatus condition search support system 100 may display a part of the condition number 511, the step label 512, the step number 513, the input parameters 514, and the output parameters 515 on a separate screen.

The condition number 511, the step label 512, the step number 513, the input parameters 514, and the output parameters 515 are not required to be managed as one piece of information.

The apparatus condition search support system 100 can classify, based on the step label 512, the input/output data that is aggregable into the same dataset, and construct a dataset based on the classification result. However, there exists input/output data that should be included in the dataset and input/output data that makes learning difficult in a case of including in the dataset. For example, in a case where the inclusion of one piece of input/output data in an existing dataset results in an increase in the number of input parameters of the dataset, the dimensionality of the parameter space formed by the learning data also increases, which makes it more difficult to search for a solution during the learning, and the accuracy of the search model tends to decrease. For example, there may be a case in which adding a small amount of data to a dataset that has 100 pieces of data and 10 input parameters results in the number of input parameters increasing to 20.

In a case where the dimensionality of the parameter space is constant, increasing the number of pieces of data is effective in improving the accuracy of the search model. Meanwhile, in a case where the dimensionality of the parameter space increases as the number of pieces of data increases, the accuracy of the search model may decrease. Therefore, it is important to suppress the increase in the number of parameters due to aggregation into a dataset as much as possible. It is desired that the increase in the number of parameters be at least not more than the number of pieces of data added to the dataset. Further, an important point in constructing the dataset is how much the number of parameters is permitted to increase relative to the increase in the number of added pieces of data.

Aggregation of input/output data that takes into account the trade-off relationship between an increase in the number of pieces data and an increase in the number of parameters requires experience and time, because the selection is required to be performed after understanding the structure of the steps and parameter types.

The apparatus condition search support system 100 of this embodiment visualizes that trade-off. As a result, the users can easily understand the trade-off relationship, and construct a high-quality dataset in a short time.

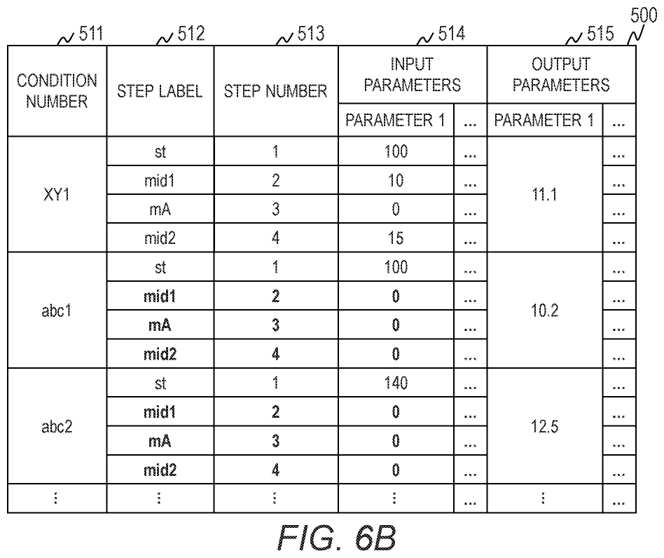

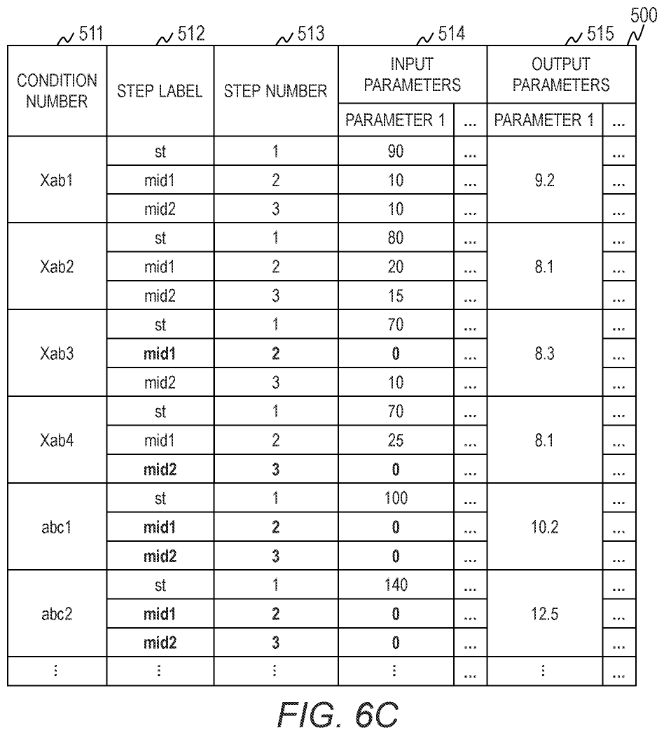

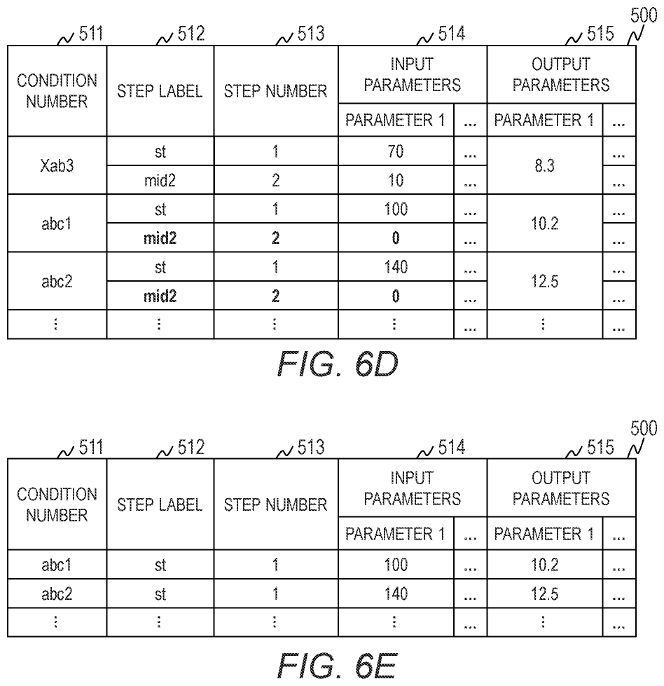

Description is now given of the method of classifying the input/output data performed by the apparatus condition search support system 100. FIG. 6A, FIG. 6B, FIG. 6C, FIG. 6D, and FIG. 6E are tables for showing update examples of the input/output data information 500 by the apparatus condition search support system 100 of the first embodiment.

The apparatus condition search support system 100 selects input/output data corresponding to two conditions including a plurality of steps, and determines whether or not the selected input/output data is aggregable based on the following first criterion and second criterion. Here, the two selected conditions are referred to as a first condition and a second condition.
(First Criterion) All step labels of the first condition are included in the step labels of the second condition.
(Second Criterion) The execution order of the step labels of the first condition is the same as the execution order in the second condition.

In a case where the first criterion and the second criterion are satisfied, the apparatus condition search support system 100 determines that the input/output data of the first condition is aggregable with the input/output data of the second condition.

It should be noted that the first criterion and the second criterion are also satisfied in a case where the step labels included in the first condition and the step labels included in the second condition are the same.

The apparatus condition search support system 100 automatically classifies input/output data and constructs the dataset based on the following procedure.
(Processing 1) The apparatus condition search support system 100 selects the condition having the largest number of steps among the input/output data information 500. The apparatus condition search support system 100 sets the selected condition as a parent condition.
(Processing 2) The apparatus condition search support system 100 searches for conditions satisfying the first criterion and the second criterion with respect to the parent condition, and generates a list of those conditions.
(Processing 3) The apparatus condition search support system 100 selects one condition from the list of conditions and sets the selected condition as the parent condition.

The input/output data that is aggregable can then be classified by repeatedly executing (processing 2) and (processing 3).
(Processing 4) After the data classification is complete, the apparatus condition search support system 100 constructs the dataset by aggregating the conditions determined to be aggregable. At this time, the step structure of the conditions included in the dataset is updated based on the parent condition. Specifically, the apparatus condition search support system 100 adds a step so that the steps included in the parent condition have the same structure as the step structure of the parent condition. The input parameters 514 and the output parameters 515 corresponding to the added step are set to zero. Even when the conditions are updated as described above, in a case where the input parameters are all zero, normally the manufacturing apparatus 150 does not operate, and hence this can be treated as a state in which there is no step.

The parameters which are permitted to be empty fields depending on the specifications of the manufacturing apparatus 150 may remain empty fields. There are parameters which are difficult to change instantaneously and for which time is required to reach a specified value, such as the temperature of a liquid medium for controlling the temperature of apparatus parts or the temperature of a heater. Regarding those parameters, as the input value of the inserted step, there are cases in which it is desired to input the same value as the value of the step before the inserted step, or to input a specific value specified by the user. The user sets those parameters so that the same value as the step before the inserted step or a specified value is input.

In the input/output data information 500 shown in FIG. 5, in a case where a condition number “XZ1” is set as the parent condition, the conditions having the condition numbers “XZ1,” “Xst1,” and “Xst2” are aggregation targets. In a case where the dataset is constructed by aggregating the conditions, the conditions are updated as shown in FIG. 6A. In a case where condition number “XY1” is set as the parent condition, conditions having the condition numbers “XY1,” “abc1,” and “abc2” are aggregation targets. In a case where the dataset is constructed by aggregating the conditions, the conditions are updated as shown in FIG. 6B. In a case where a condition number “Xab1” is set as the parent condition, the conditions having the condition numbers “Xab1,” “Xab2,” “Xab3,” “Xab4,” “abc1,” and “abc2” are aggregated targets. In a case where the dataset is constructed by aggregating the conditions, the conditions are updated as shown in FIG. 6C. In a case where the condition number “Xab3” is set as the parent condition, the conditions having the condition numbers “Xab3,” “abc1,” and “abc2” are aggregation targets. In a case where the dataset is constructed by aggregating the conditions, the conditions are updated as shown in FIG. 6D. In a case where a condition number “Xab4” is set as the parent condition, the conditions having the condition numbers “Xab4,” “abc1,” and “abc2” are aggregation targets. In a case where the condition number “abc1” is set as the parent condition, the conditions having the condition numbers “abc1” and “abc2” are aggregation targets. In a case where the dataset is constructed by aggregating the conditions, the conditions are updated as shown in FIG. 6E.

In the conditions to be aggregated, there may be a case in which the values of the input parameters in the same step only include a condition having one value other than zero and the condition into which the parameter of the step is to be inserted by the aggregation (in other words, the data before aggregation does not include the parameter of the relevant step). In this case, in a case where the one value other than zero is represented by X1, it is desired to set X1 in the value of the parameter when inserting the step after aggregation. The reason for this is that, compared with a dataset in which the value of the parameter is only X1, a dataset in which the value of the relevant parameter is X1 and zero has a larger data space, and thus the time taken to search for the solution in such a dataset is longer.

The model (for example, a regression model) which learns the relationship between the inputs and the output of the manufacturing apparatus 150 is usually trained by using data having the same parameter structure, and thus the above-mentioned step insertion becomes important. In addition, as described above, it takes time and effort to manually classify conditions having different step structures, and thus incorporating a function to automate or support classification and aggregation is also important in order to improve convenience and expand the number of users.

Description is given above of a method of determining and aggregating aggregable input/output data, but description is now given of an example of input/output data for which aggregation is not desirable. The aggregation method described above can also be applied to conditions having different parameters and step structures. For example, in a case where the step labels and the step orders of the first condition and the second condition are different, in principle it is possible to aggregate data by inserting all of the steps of both conditions. However, in a case where it is assumed that the number of parameters of the first condition and the second condition is 10 each, the number of parameters after aggregation increases to 20 at most. In a case where the increase in the number of parameters is larger than the increase in the number of pieces of data in the dataset due to aggregation, as described above, it becomes difficult to search for the solution. Therefore, the above-mentioned aggregation is not desirable.

FIG. 7 is a diagram for illustrating an example of a screen presented by the apparatus condition search support system 100 of the first embodiment in a case where the create dataset button 411 is operated. FIG. 8 is a table for showing an example of a screen presented by the apparatus condition search support system 100 of the first embodiment in a case where a manual creation button is operated.

In a case where the create dataset button 411 is pressed, an automatic creation button 420 and a manual creation button 421 are newly displayed in the operation button display field 401. In the operation field 402, dataset information 700 is displayed.

The dataset information 700 is information having a table format, and stores entries including a dataset name 711, a parent condition 712, a number of conditions 713, a number of steps 714, a creation date and time 715, and a creation method 716. There is one entry for each dataset.

The fields included in the entry are not limited to those described above. For example, fields storing the number of parameters of each of the input data and the output data may be included.

The parent condition 712 is a field which stores identification information on the parent condition at the time of classification determination. The number of conditions 713 is a field which stores the number of conditions (input/output data) included in the dataset. The number of steps 714 is a field which stores the number of steps included in the conditions included in the dataset. The creation date and time 715 is a field which stores the date and time when the dataset is created. The creation method 716 is a field which stores the dataset creation method. Any one of “automatic” and “manual” is stored in the creation method 716.

In a case where the user selects an entry in the dataset information 700, the apparatus condition search support system 100 may display a list of data forming the dataset. For example, in a case where the entry “XZ1-auto-01” is selected, a screen like that shown in FIG. 6A is displayed.

In a case where the automatic creation button 420 is pressed, the apparatus condition search support system 100 executes the above-mentioned classification processing and dataset construction processing. In FIG. 7, the datasets having a name which includes “auto” are automatically created datasets.

In a case where the manual creation button 421 is pressed, the apparatus condition search support system 100 presents an operation field 800 shown in FIG. 8 in the operation field 402. The operation field 800 stores entries including a parent condition selection 811, a data selection 812, a condition number 813, a step label 814, a step number 815, input parameters 816, and output parameters 817. There is one entry for each condition.

The condition number 813, the step label 814, the step number 815, the input parameters 816, and the output parameters 817 are the same fields as the condition number 511, the step label 512, the step number 513, the input parameters 514, and the output parameters 515, respectively. The parent condition selection 811 is a field for selecting the condition corresponding to the entry as the parent condition. The data selection 812 is a field for selecting conditions for aggregation.

In a case where the parent condition selection 811 of a given entry is selected, the apparatus condition search support system 100 executes the classification processing described above, and highlights and displays the aggregable conditions. As shown in FIG. 8, in a case where the condition “Xab1” is selected as the parent condition, the conditions “abc1,” “abc2,” “Xab1,” “Xab2,” “Xab3,” and “Xab4” are highlighted and displayed. The user refers to the highlighted entry, and sets a check mark in the data selection 812 of the conditions to be aggregated.

As described above, manual classification of the conditions requires time and effort, and hence a function which supports classification is useful for improving convenience and expanding the number of users.

The above description is based on the assumption that, in one condition, all output parameter values are set, but there are cases in which an output parameter is not measured. Generally, a condition in which an output parameter value is not set is not usable as learning data for the model. Therefore, a predicted value of the output parameter not having a value is obtained by generating a model by using a condition in which all input parameters and output parameters have a value to learn the input/output relationship, and inputting the values of the input parameters to the model. The input/output data having the supplemented output parameter value can be used as learning data. As a result, the number of pieces of learning data can be increased.

However, the predicted value includes an error due to the learning by the model, and thus it is desired that the user be able to choose whether or not to use input/output data supplemented with a predicted value. At this time, the apparatus condition search support system 100 highlights and displays the predicted value or the cell in which the predicted value is input, for example, by changing the color of the cell, so that the predicted value or cell is visible.

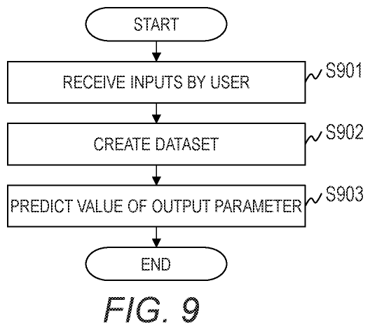

FIG. 9 is a flowchart for illustrating an example of processing executed by the apparatus condition search support system 100 of the first embodiment. A s description of dataset construction is given with reference to FIG. 9.

The apparatus condition search support system 100 receives inputs by the user via the screen 400 (Step S901).

The apparatus condition search support system 100 creates a dataset based on the inputs by the user (Step S902).

Specifically, in a case where the automatic creation button 420 is pressed, the apparatus condition search support system 100 automatically classifies the conditions and creates a dataset based on the classification result. In a case where the manual creation button 421 is pressed, the apparatus condition search support system 100 classifies the conditions based on the parent condition specified by the user, and creates a dataset based on the conditions selected by the user.

The apparatus condition search support system 100 predicts the value of the output parameter for the condition in which an output parameter value is not set (Step S903). The apparatus condition search support system 100 sets the predicted value in the output parameter.

In order to implement the processing of Step S903, an operation button for predicting the value of the output parameter is provided in the operation button display field 401 or the operation field 402. The processing of Step S903 is executed in a case where the user selects a dataset and presses the corresponding operation button.

It is not required to specify a dataset. In this case, processing is executed for all datasets.

In a case where a condition in which an output parameter value is not set does not exist, the processing of Step S903 can be omitted.

In addition, the user may select whether or not to include input/output data including a predicted value in the dataset.

FIG. 10 is a diagram for illustrating an example of a screen presented by the apparatus condition search support system 100 of the first embodiment in a case where the create workspace button 412 is operated.

In a case where the create workspace button 412 is pressed, a create new button 430, a copy button 431, a set preprocessing button 432, a set calculation button 433, and a display result button 434 are newly displayed in the operation button display field 401. In the operation field 402, workspace information 1000 is displayed.

The workspace information 1000 is information having a table format, which stores entries including a workspace name 1011, a dataset name 1012, a parent condition 1013, a number of conditions 1014, a number of steps 1015, a creation date and time 1016, a calculation start date and time 1017, and a calculation status 1018. There is one entry for each workspace.

The fields included in the entry are not limited to those described above. For example, a field which stores the number of parameters of each piece of input data and each piece of output data may be included.

The dataset name 1012, the parent condition 1013, the number of conditions 1014, the number of steps 1015, and the creation date and time 1016 are the same fields as the dataset name 711, the parent condition 712, the number of conditions 713, the number of steps 714, and the creation date and time 715, respectively. The workspace name 1011 is a field which stores the name of the workspace. The name of the workspace may be set automatically or may be set manually in the field by the user. The calculation start date and time 1017 is a field which stores the start date and time of the search processing. The calculation status 1018 is a field which stores the execution state of the calculation in the search processing.

In a case where the create new button 430 is pressed, the apparatus condition search support system 100 presents a dataset selection screen (not shown), and in a case where a dataset selection result is received from the user, the apparatus condition search support system 100 registers an entry in the workspace information 1000.

In a case where the user selects any entry in the workspace information 1000 and presses the copy button 431, the apparatus condition search support system 100 adds the entry to the workspace information 1000 and copies the contents of the selected entry to the added entry. In the workspace name 1011, a value different from that of the selected entry is set.

The apparatus condition search strongly depends on the dataset and the calculation settings, and hence, in order to improve user convenience during the apparatus condition search, it is important to simplify changes to the dataset and the calculation settings, as well as to simplify management of the change result. Therefore, as illustrated in FIG. 10, user convenience can be improved by managing the dataset, the calculation settings, and calculation execution state for each workspace.

In a case where any one of the set preprocessing button 432, the set calculation button 433, or the display result button 434 is pressed, a screen corresponding to the relevant button is displayed. Details of the screens are described later. In a case where the search processing is not complete, the apparatus condition search support system 100 controls so that operation of the display result button 434 is not received, or the screen is not displayed even when the display result button 434 is operated.

FIG. 11 is a diagram for illustrating an example of a screen presented by the apparatus condition search support system 100 of the first embodiment in a case where the set preprocessing button 432 is operated.

The screen 1100 includes a display field 1101, setting fields 1102, 1103, and 1104, and an operation field 1105.

The display field 1101 is a field which displays information on the workspace in use. The setting field 1102 is a field for setting target values of the output parameters. The user sets the target values of the output parameters in a setting table 1120.

The setting field 1103 is a field for setting the search range of the input parameters. The user sets, in a setting table 1130, the maximum value and the minimum value of the input parameters, and the number of values to be added that do not fall between the maximum value and the minimum value at the time of search. The reason for adding values to the search range is that, among the input parameters, there are parameters, for example, in a gas inflow system, in which the control range has zero inflow when completely closed and lower and upper limits that are not zero for inflow control.

The setting field 1104 is a field for setting input parameters in which the values are changed discretely during a search. The user sets, in a setting table 1140, a discrete change pattern for any of the input parameters. Through setting of a discrete change pattern, it becomes possible to search for values of input parameters that can take only discrete values or can be set only to discrete values.

The setting fields 1102, 1103, and 1104 include a save button for saving the set contents and a load button for loading the saved contents.

The operation field 1105 is a field for controlling input to the setting fields 1102, 1103, and 1104 and for controlling execution of preprocessing.

An edit button 1150 is a button for enabling input to the setting fields 1102, 1103, and 1104. In a case where the edit button 1150 is pressed, the calculation execution state is initialized.

An execution button 1151 is a button for transitioning to an execution phase of the calculations relating to preprocessing. In a case where the execution button 1151 is pressed, the settings fields 1102, 1103, and 1104 are controlled not to receive inputs. The calculation results are managed in association with various settings in order to avoid confusion in the association with the calculation results in a case where various settings are changed after execution of a calculation. In particular, in a case where a plurality of calculations are executed, it is required to switch between editing the settings and executing the calculations, because when a setting is changed during a calculation, the change may cause an error in the calculation, for example, the calculation may stop.

In a case where the execution button 1151 is pressed, the apparatus condition search support system 100 may check the setting contents of the setting field 1102 and determine whether or not the correct value is set. This makes it possible to prevent errors from occurring in advance.

A calculation table 1155 displays the name of the calculation for preprocessing, an execution button, and the execution state of the calculation. In this embodiment, each calculation is executed in order from the top. The execution button for each calculation is not enabled until the previous calculation is complete. For example, the execution button for “Preprocess 2” is enabled after “Preprocess 1” is complete. This makes it possible for the user to visually grasp the execution state of the calculations, improving convenience.

A log field 1156 displays a log indicating the execution state or execution result of the calculation.

The result folder button 1152 is a button for referring to a folder in which output data, for example, generated by execution of a calculation is stored. A transition button 1153 is a button for transitioning to a phase before the setting of preprocessing. For example, in a case where the transition button 1153 is pressed, the state transitions to the state of FIG. 10. A transition button 1154 is a button for transitioning to a calculation setting phase. For example, in a case where the transition button 1154 is pressed, the state transitions to the state of FIG. 12. However, the transition button 1154 is not enabled until all calculations are complete.

FIG. 12A and FIG. 12B are diagrams for illustrating an example of a screen presented by the apparatus condition search support system 100 of the first embodiment in a case where the set calculation button 433 is operated.

The screen 1200 includes setting fields 1201 and 1202, an operation field 1203, and a display field 1204.

The setting field 1201 is a field for performing settings for calculations relating to search model learning and apparatus condition search.

The user selects the format of the model to be used and the search method for the apparatus conditions using the model in a model selection table 1210. In the model selection table 1210, the available search methods are displayed in a selectable format in accordance with the format of the selected model.

The model format can be selected from, for example, simple regression, support vector regression, a regression tree, and regression using a neural network. Further, the search method can be selected from among, for example, a random search, a grid search, and a gradient method.

The user sets the values of the parameters for controlling the apparatus condition search in parameter setting tables 1211 and 1212. The parameter setting table 1211 is a table for setting parameters which depend on the model format and the search method. The parameter setting table 1212 is a table for setting parameters which do not depend on the model format and the search method.

In a case where “kernel ridge regression” is selected as the model format and “random” is selected as the search method, parameters like those illustrated in FIG. 12A are displayed in the parameter setting table 1211 and the parameter setting table 1212.

Cnum is a parameter which adjusts the number of input parameters that are changed at one time during a search. searchN is a parameter which adjusts the number of conditions to be searched. Nprint is a parameter which adjusts a display interval of intermediate results. In a case where the number of search attempts that have been executed is equal to the value set in Nprint, the apparatus condition search support system 100 displays the processing conditions obtained so far. Nkf is a parameter which adjusts the number of data divisions in cross-validation.

A search cost table 1213 displays a recommended number of searches and an estimated value of the calculation time. In addition, a recommended calculation time may also be displayed. The number of searches and the calculation time are calculated based on the settings in the model selection table 1210 and the parameter setting tables 1211 and 1212.

The setting field 1202 is a field for performing settings relating to hyperparameters.

In a case of executing a hyperparameter search, the user presses a search button 1220. The apparatus condition search support system 100 searches for hyperparameters, and displays the search result in a hyperparameter table 1221. In a case where manually setting the hyperparameters, the user presses a setting button 1222 and sets the values in a setting table 1223.

The operation field 1203 is a field for controlling input to the setting fields 1201, and 1202 and for controlling the search model learning and the apparatus condition search.

An edit button 1230 is a button for enabling input to the setting fields 1201 and 1202. In a case where the edit button 1230 is pressed, the calculation execution state is initialized.

An execution button 1231 is a button for transitioning to an execution phase of the calculations. In a case where the execution button 1231 is pressed, the settings fields 1201 and 1202 are controlled not to receive inputs.

A calculation table 1235 and a log field 1236 are the same fields as the calculation table 1155 and the log field 1156.

A result folder button 1232 is a button for referring to a folder in which output data, for example, generated by execution of a calculation is stored. A transition button 1233 is a button for transitioning to a phase before the setting of the calculation. For example, in a case where the transition button 1233 is pressed, the state transitions to the state of FIG. 11. A transition button 1234 is a button for transitioning to a result reference phase. For example, in a case where the transition button 1234 is pressed, the result is displayed in the display field 1204. However, the transition button 1234 is not enabled until all calculations are complete.

The display field 1204 is a field for displaying the apparatus conditions obtained by the calculations. The display field 1204 displays a plurality of apparatus conditions.

As described above, the apparatus condition search support system 100 of the first embodiment can support various inputs for searching for the apparatus conditions of a manufacturing apparatus. In particular, the apparatus condition search support system 100 of the first embodiment has a feature in supporting the construction of learning datasets, thereby reducing the time and effort required for optimizing apparatus conditions and increasing efficiency. Further, the apparatus condition search support system 100 supports various inputs, and thus can be used even by an engineer who does not have specialized knowledge.

### Second Embodiment

In a second embodiment of this invention, a difference from the first embodiment is that the apparatus condition search support system 100 is used by a plurality of users.

A plurality of user terminals 102 may each be coupled to the apparatus condition search support system 100 via a different network. For example, a plurality of user terminals 102 may be coupled via the Internet or via an intranet. A firewall and an authentication server are installed between the user terminals 102 and the apparatus condition search support system 100, and user authentication and access control are performed.

The users can access the apparatus condition search support system 100 by operating the user terminal 102, input the input data and the output data, create a dataset, create a workspace, perform the calculation settings, and obtain the apparatus conditions. Further, the users can transmit the apparatus conditions to the proof-of-concept system 101, and obtain the proof-of-concept result. In addition, the users can register the proof-of-concept result together with the apparatus conditions in the apparatus condition search support system 100. Through the registration of the proof-of-concept result as new learning data, the search accuracy of the apparatus conditions can be improved.

Through the registration of learning data by a plurality of users, apparatus conditions, datasets, proof-of-concept results, and the like can be shared, and thus the plurality of users can collaborate to search for apparatus conditions.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, Python and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer system for supporting a search for an apparatus condition for controlling a manufacturing apparatus that performs processing, the computer system comprising at least one computer including:
a calculation device;
a storage device coupled to the calculation device; and
a coupling interface coupled to the calculation device,
the processing including at least one manufacturing step,
the computer system being configured to:
present a first interface for receiving input of a plurality of pieces of learning data, a piece of learning data includes a combination of a value of at least one input parameter which is the apparatus condition and a value of at least one output parameter which is a result of the processing;
store the plurality of pieces of learning data input via the first interface in the storage device;
analyze a structure of the at least one manufacturing step of the processing in a piece of standard learning data and a structure of the at least one manufacturing step of the processing in a piece of other learning data, and based on a result of the analysis, execute classification processing of identifying a piece of learning data which is aggregable with a same dataset as the piece of standard learning data;
generate a dataset by aggregating the plurality of pieces of learning data based on a result of the classification processing;
execute, by using the dataset, processing of training a model for predicting the value of the at least one output parameter from the value of the at least one input parameter, and store the generated model in the storage device;
execute search processing of searching for the value of the at least one input parameter based on the model and a target value of the at least one output parameter; and
present a second interface for displaying a result of the search processing.

2. The computer system according to claim 1,
wherein the computer system is configured to:
select the piece of standard learning data from among the plurality of pieces of learning data;
select a piece of target learning data from among the plurality of pieces of learning data;
determine that the piece of target learning data is aggregable with the same dataset as the piece of standard learning data in a case where all manufacturing steps of the processing in the piece of target learning data are included in the processing of the piece of standard learning data, and an execution order of all the manufacturing steps of the processing in the piece of target learning data matches an execution order of the processing of the piece of standard learning data.

3. The computer system according to claim 2, wherein the computer system is configured to format, in a case where the dataset is generated by using at least one of piece of learning data which is aggregable with the piece of standard learning data, the at least one of piece of learning data which is aggregable such that the structure of the at least one manufacturing step of the processing in the at least one of piece of learning data which is aggregable is the same as the structure of the at least one manufacturing step of the processing in the piece of standard learning data.

4. The computer system according to claim 2, wherein the computer system is configured to present a third interface for specifying the piece of standard learning data.

5. The computer system according to claim 2, wherein the computer system is configured to present a fourth interface for selecting at least one learning data to be aggregated.

6. An apparatus condition search support method of supporting a search for an apparatus condition for controlling a manufacturing apparatus that performs processing, the apparatus condition search support method being executed by a computer system,
the computer system including at least one computer including:
a calculation device;
a storage device coupled to the calculation device; and
a coupling interface coupled to the calculation device,
the processing including at least one manufacturing step,
the apparatus condition search support method including:
a first step of presenting, by the at least one computer, a first interface for receiving input of a plurality of pieces of learning data, a piece of learning data includes a combination of a value of at least one input parameter which is the apparatus condition and a value of at least one output parameter which is a result of the processing;
a second step of storing, by the at least one computer, the plurality of pieces of learning data input via the first interface in the storage device;
a third step of analyzing, by the at least one computer, a structure of the at least one manufacturing step of the processing in a piece of standard learning data and a structure of the at least one manufacturing step of the processing in a piece of other learning data, and based on a result of the analysis, execute classification processing of identifying a piece of learning data which is aggregable with a same dataset as the piece of standard learning data;
a fourth step of generating, by the at least one computer, a dataset by aggregating the plurality of pieces of learning data based on a result of the classification processing;
a fifth step of executing, by the at least one computer, by using the dataset, processing of training a model for predicting the value of the at least one output parameter from the value of the at least one input parameter, and storing the generated model in the storage device;
a sixth step of executing, by the at least one computer, search processing of searching for the value of the at least one input parameter based on the model and a target value of the at least one output parameter; and
a seventh step of presenting, by the at least one computer, a second interface for displaying a result of the search processing.

7. The apparatus condition search support method according to claim 6, wherein the third step includes the steps of:
selecting, by the at least one computer, the piece of standard learning data from among the plurality of pieces of learning data;
selecting, by the at least one computer, a piece of target learning data from among the plurality of pieces of learning data; and
determining, by the at least one computer, that the piece of target learning data is aggregable with the same dataset as the piece of standard learning data in a case where all manufacturing steps of the processing in the piece of target learning data are included in the processing of the piece of standard learning data, and an execution order of all the manufacturing steps of the processing in the piece of target learning data matches an execution order of the processing of the piece of standard learning data.

8. The apparatus condition search support method according to claim 7, wherein the fourth step includes a step of formatting, by the at least one computer, at least one of piece of learning data which is aggregable such that the structure of the at least one manufacturing step of the processing in the at least one of piece of learning data which is aggregable is the same as the structure of the at least one manufacturing step of the processing in the piece of standard learning data.

9. The apparatus condition search support method according to claim 7, wherein the third step includes a step of presenting, by the at least one computer, a third interface for specifying the piece of standard learning data.

10. The apparatus condition search support method according to claim 7, wherein the fourth step includes a step of presenting, by the at least one computer, a fourth interface for selecting at least one learning data to be aggregated.
